(19) United States
(12) Patent Application Publication
(10) Pub. No.: US 2022/0076109 A1
(43) Pub. Date: Mar. 10, 2022

(54) SYSTEM FOR CONTEXTUAL AND POSITIONAL PARAMETERIZED RECORD BUILDING

(71) Applicant: IQREATE INFOTECH PVT LTD, Bengaluru (IN)

(72) Inventors: Rakesh Srivastava, Bangalore (IN); Kiran Kumar, Chennai (IN); Nitin Gupta, Delhi (IN)

(73) Assignee: IQREATE INFOTECH PVT LTD, Bengaluru (IN)

(21) Appl. No.: 17/467,920

(22) Filed: Sep. 7, 2021

(30) Foreign Application Priority Data
Sep. 8, 2020 (IN) 202041038647

(51) Int. Cl. G06N 3/063; G06N 3/04; H04L 9/32

(52) U.S. Cl. CPC G06N 3/063; H04L 9/3247; G06N 3/0454

(57) ABSTRACT

Provided is a system for contextual and positional parameterized record building. The system provides a mechanism to track any data record, information element or its parts to extract graphical/logical and contextual location in source documents and construct a data tree representation using a data representation module. The information extraction is enabled by a learning approach that incorporates graphical positional features into the model building process. A prediction architecture includes a gate network having a plurality of gates/neurons. Each gate/neuron is associated with an activation function based on a pre-built logic to perform a specific operation and operates on signals received at the gate/neuron. A record building module constructs one or more records based on candidate data values derived from the data tree representation using the prediction architecture. The candidate data values are wrapped in signals and fed to gates/neurons to construct the one or more records.

### RELATED APPLICATIONS

This application claims priority to, and benefit from Indian Provisional Application Serial No. 202041038647, filed on Sep. 8, 2020, entitled “METHOD AND SYSTEM FOR CONTEXTUAL AND POSITIONAL PARAMETERIZED RECORD BUILDING THROUGH MACHINE LEARNING”, the entire content of which is hereby incorporated herein by reference in its entirety.

### FIELD

Various embodiments of the present disclosure generally relate to information extraction from data sources, and more specifically to information extraction from source documents, converting the extracted information to structured data using machine learning approaches to identify structure, layout and context of data for efficient record building.

### BACKGROUND

In the world of information extraction from documents, there are several ways to address the issues around extracting information from documents. The challenges are generally addressed through manual data wrangling or using Robotic Process Automation (RPA) tools that are bound to the fixed structure of a document and are tremendously cost prohibitive. Existing solutions limit scalability of the information extraction process, and often require domain experts to spend nearly 70-80% of the time in preparing, wrangling and extracting data. Having to deal with such multiple solutions results in challenges related to integration and increased overheads.

Existing techniques for information extraction use text mining software and employ Natural Language Processing (NLP) algorithms to interpret meaning from huge volumes of text. Companies utilize NLP to identify patterns, themes, and topics of interest. For example, if a company wishes to know more about its customers or employees, it may use text analytics software to mine and analyze data from customer and employee emails, feedback, and tweets. In simple terms, text analytics software converts textual data into meaningful information.

However, none of the text analytics software address the three core challenges:

The first challenge is to extract data that is not a standard entity defined in NLP.
The second challenge is to extract data when the meaning of the data is provided by other contextual markers outside of the extracted data.
The third challenge is to identify the contextual markers when they are structural in nature, especially when the structure or layout of the data is tabular.

Historically, information extraction from documents has involved directly determining context from the text that surrounds a candidate segment without focusing on graphical or visual position-based relations that exist in the information. In this context, it tends to make extraction complex when multiple relations crisscross the relevant text in a given section of the document. Probabilistic approaches cannot be directly used to ensure higher precision in the extraction process in this case. The combination of rules and predictive approaches provides a better tradeoff between training overheads and verification needs of a high-quality data repository. The situation is further complicated by the presence of various file formats that represent the positional information quite differently.

Accordingly, in light of the foregoing difficulties and prior art, there exists a need for an improved method and system for information extraction and record building.

Limitations and disadvantages of conventional and traditional approaches will become apparent to one of ordinary skill in the art, through comparison of described systems with some aspects of the present disclosure, as set forth in the remainder of the present application and with reference to the drawings.

### SUMMARY

A system for contextual and positional parameterized record building is provided substantially as shown in and/or described in connection with, at least one of the drawings, as set forth more completely in the claims. The system includes a prediction architecture which comprises an ensemble of models. Each model in the ensemble of models includes a gate network having a plurality of gates/neurons. Each gate/neuron is associated with an activation function based on a pre-built logic to perform a specific operation and is configured to operate on one or more signals received at the gate/neuron. The system further includes a data representation module configured to perform hybrid modeling on a plurality of data elements to represent data in a structured space and an unstructured space. The data representation module is configured to construct a data tree representation using the prediction architecture to correlate the structured space and the unstructured space. The data tree representation comprises a plurality of hierarchical blocks to represent the plurality of data elements along with relative positions of each of the plurality of data elements with respect to each other. The system further includes a record building module configured to construct one or more records based on one or more candidate data values derived from the data tree representation using the prediction architecture. The one or more candidate data values derived from the data tree representation are wrapped in one or more signals and fed to one or more gates/neurons of the plurality of gates/neurons to construct the one or more records.

These and other features and advantages of the present disclosure may be appreciated from a review of the following detailed description of the present disclosure, along with the accompanying drawings in which like reference numerals refer to like parts throughout.

### BRIEF DESCRIPTION OF THE DRAWINGS

FIG. 1 is a diagram that illustrates a system for contextual and positional parameterized record building in accordance with an exemplary embodiment of the disclosure.

FIG. 2 is a block diagram that illustrates data extraction through contextual markers and structural markers in accordance with an exemplary embodiment of the disclosure.

FIG. 3 is a diagram that illustrates a prediction workflow of a prediction gate network for data extraction in accordance with an exemplary embodiment of the disclosure.

FIG. 4 is a diagram that illustrates a process workflow for contextual and positional parameterized record building in accordance with an exemplary embodiment of the disclosure.

### DETAILED DESCRIPTION

The following described implementations may be found in the disclosed system for contextual and positional parameterized record building. The system represents data elements extracted from a source document in a standard format that identifies the relationship between the data elements both from layout/position and from context perspective in order to provide meaningful record building and information extraction. Further, the system provides a mechanism to track any data record, information element or its parts to extract graphical/logical and contextual location in the source document. The information extraction is enabled by a learning approach that incorporates graphical positional features into the model building process.

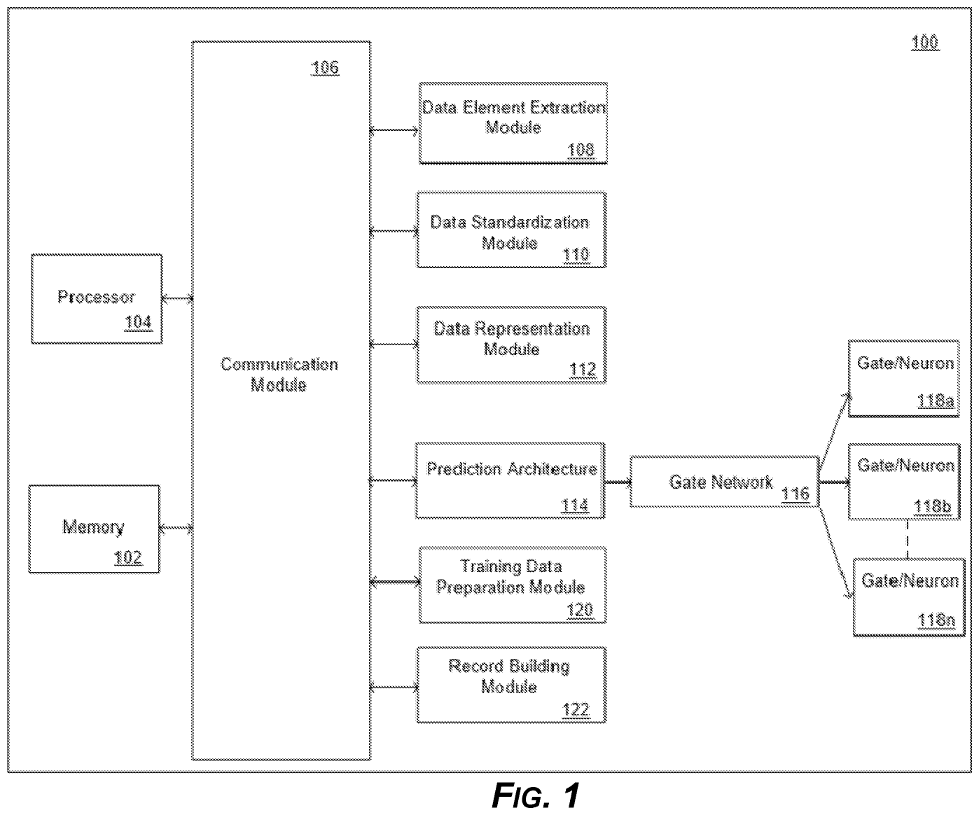

FIG. 1 is a diagram that illustrates a system for contextual and positional parameterized record building in accordance with an exemplary embodiment of the disclosure. Referring to FIG. 1, there is shown a system 100, which includes a memory 102, a processor 104, a communication module 106, a data element extraction module 108, a data standardization module 110, a data representation module 112, a prediction architecture 114, a gate network 116, a plurality of gates/neurons 118a-118n, a training data preparation module 120 and a record building module 122.

The memory 102 may comprise suitable logic, and/or interfaces, that may be configured to store instructions (for example, computer readable program code) that can implement various aspects of the present disclosure.

The processor 104 may comprise suitable logic, interfaces, and/or code that may be configured to execute the instructions stored in the memory 102 to implement various functionalities of the system 100 in accordance with various aspects of the present disclosure. The processor 104 may be further configured to communicate with various modules of the system 100 via the communication module 106.

The communication module 106 may comprise suitable logic, interfaces, and/or code that may be configured to transmit data between modules, engines, databases, memories, and other components of the system 100 for use in performing the functions discussed herein. The communication module 106 may include one or more communication types and utilizes various communication methods for communication within the system 100.

The data element extraction module 108 may comprise suitable logic, interfaces, and/or code that may be configured to identify and extract a plurality of data elements from one or more source documents. The plurality of data elements may include, but are not limited to, text, images, words, letters, image coordinates, graphical lines, contextual and structural metadata, complex entities and high-level formatting constructs that include paragraphs, sentences, tabular constructs or layouts and cells along with actual text.

The data element extraction module 108 is configured to extract the plurality of data elements from a diverse set of file formats including, but not limited to, PDF, Hypertext Markup Language (HTML), TEXT, .XLS and WORD, which includes extraction of words and letters primarily, followed by graphical lines and image coordinates embedded in specific file formats that a user uploads. Specific features of the text such as, but not limited to, font family, size and color, are also extracted.

Depending on the file format, the information for extraction may be directly read from the file or may be derived. Various software may be utilized for reading the specific file formats that include either open source or may be provided by an entity that created the file format. These are integrated into the pipeline for the extraction workflow of the data element extraction module 108.

The data standardization module 110 may comprise suitable logic, interfaces, and/or code that may be configured to normalize the plurality of data elements extracted from the one or more source documents. The data standardization module 110 is configured to normalize the plurality of data elements by connecting graphical lines that are broken or overlapping, in the case of HTML content, identifying various Cascading Style Sheets (CS S) pathways that identify different word constructs within a Document Object Model (DOM), removing redundancies and inconsistencies in certain document formats, removing text hidden by overlapping layers and unifying lines overlapping each other.

The data standardization module 110 is configured to perform document content and structure parsing to normalize metadata and words from different file formats. In some cases, additional processing is performed on data read from a file format in order to pull out specific metadata that is required. For instance, graphical lines and text in the case of image representations are parsed using digital image parsing and Optical Character Recognition (OCR) software. The normalized format may then be used to load up models with all relevant features for any particular use case.

The data standardization module 110 is configured to transform raw data found in documents for direct consumption by other modules of the system 100. Higher level mapping or deductive logic may even involve user interaction on a regular basis. Hooks may also be provided to easily accommodate these checkpoints to reduce overheads.

The data standardization module 110 is further configured to transform data into a standardized format using validation rules based on business logic, for all values that are of similar type and do not need any conversion (for example, obtaining all dates into a mm/dd/yyyy format).

The data representation module 112 may comprise suitable logic, interfaces, and/or code that may be configured to perform hybrid modeling on the plurality of data elements to represent the data in a structured space and an unstructured space. The structured space comprises data represented as one or more records built from one or more fields. The unstructured space comprises one or more documents represented as one or more blocks. Each block of the one or more blocks comprises one or more chunks, and the one or more chunks comprise one or more contiguous words occurring in the document. For each block of the one or more chunks from different values from one or more records, the data representation module 112 is configured to generate one or more block signatures. A set of combinations of chunks that form related field values of one or more records are created from a particular block signature.

The data representation module 112 is configured to extract one or more contextual markers from around the one or more chunks. The one or more contextual markers provide additional context.

The data representation module 112 is further configured to extract one or more structural markers. The one or more structural markers may include visual markers for one or more field values extracted from scenarios where textual context is not present. These visual markers may include, but are not limited to, absolute coordinates for a field, relative coordinates between fields, and relative positioning with respect to other page elements that include keywords, headers, images, and graphical lines.

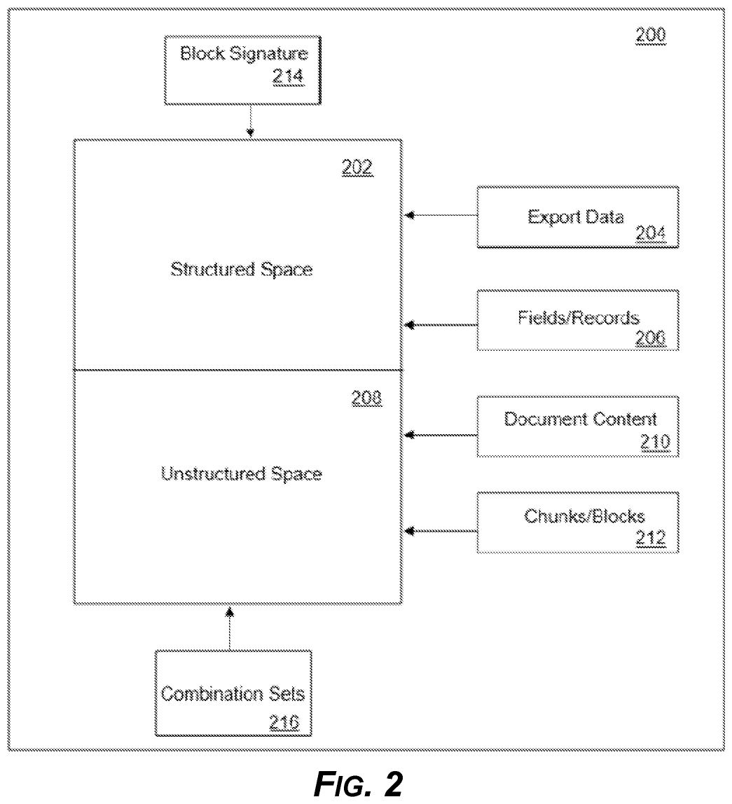

Further details related to the extraction of contextual markers and structural markers are illustrated in conjunction with FIG. 2.

The data representation module 112 is further configured to construct a data tree representation using the normalized output from the data standardization module 110. This tree representation is then utilized by the prediction architecture 114 to create connections between the unstructured and structured spaces. The data tree representation comprises a plurality of hierarchical blocks to represent the plurality of data elements along with relative positions of each of the plurality of data elements with respect to each other.

The data tree representation indicates the conversion of all discovered and deduced graphical and text data into a single tree representation that preserves the hierarchy of a structural organization. All data are represented as completely bound “blocks” in the tree representation along with their relative positions with respect to each other. As such, each block is aware of its “left”, “right”, “up” and “down” neighbors and of its parent node and its children nodes. This allows the prediction logic of the prediction architecture 114 to be able to build relations between different candidate values more effectively and quickly. The file-format independent nature of this representation enables the prediction architecture 114 to deal with all kinds of document data representations in a more generic and adaptive manner.

A typical hierarchy is depicted as follows:

The smallest block of document data is the word block. This will roll up to higher level blocks which consolidate into pages and then into the document. Each block contains the lower level blocks and certain metadata such as coordinates of the bounding rectangle that encloses all the words in the block and its children. This also includes text features such as, but not limited to, color, font, and size, where the file formats provide such information.

For instance, a paragraph may be represented as hierarchical blocks. The smallest block is the ‘Word’. It is connected to blocks on the left and right. The ‘Word’ block is contained in a ‘Sentence’ block. The ‘Sentence’ block is connected to right and left sentences and is contained in a ‘Paragraph’ block that is contained in a ‘Page’ block. The ‘Page’ blocks are contained in a ‘Document’ block.

In another instance, a table may be represented as hierarchical blocks. The smallest block is the ‘Cell’. It is connected to blocks on the left and right and up and down. In this case, there is no containment other than the ‘Page’ block which resides in the ‘Document’ block. Each block also stores the rectangular coordinates within which all its words fall. Some of the constructs such as sentences may be discovered using standard sentence tokenization algorithms.

The prediction architecture 114 comprises an ensemble of models, each model in the ensemble of models comprising the gate network 116 having the plurality of gates/neurons 118a-118n. Each gate/neuron is associated with an activation function based on a pre-built logic to perform a specific operation and is configured to operate on one or more signals received at the gate/neuron.

The gate network 116 organizes the plurality of gates/neurons 118a-118n into a correct sequence based on dependencies between the plurality of gates/neurons 118a-118n and activates appropriate gates/neurons for a scenario which may include, but is not limited to, contextual data, graphical data and/or tabular data within the various modules. In some embodiments, an individual gate/neuron encapsulates an entire gate network to provide a hierarchical prediction flow/logic.

In accordance with an embodiment, the prediction architecture 114 includes the gate network 116 that allows the creation of multiple ensembles of models based on the needs of each business case for each stage of the information extraction. The models are auto selected by strategy manager gates that evaluate a best fit ensemble for any given use case.

The gate network 116 comprises a plurality of nodes representing the neurons/gates and the lines connecting the nodes to form the shape of the gate network 116. The signals pass from gate to gate through links between the gates. A gate may open or close to a signal depending on an activation function. The gate network 116 comprises activation functions based on a predefined logic. In some embodiments, an individual gate/neuron encapsulates an entire gate network to provide a hierarchical prediction flow/logic.

The prediction architecture 114 comprises the following components: Network, Gate/Neuron, and Signal.

Network: The network is a container of gates, their relationships and the signals that pass through it. The network is the higher-level manager of gates. it organizes the gates into the right sequence and utilizes the right ones for a given scenario.

Gate/Neuron: The specific model that can handle each type of contextual marker or combination of contextual markers are wrapped into a gate/neuron. The gate/neuron has an activation function that is based on a pre-built logic instead of mathematical or statistical methods used in traditional neural networks.

The gate/neuron may even wrap a more complex ensemble of models by utilizing a network internally which may either be the gate network 116 or a traditional neural network (TNN). The activation logic of the gate acts on the signal that it receives. The gate is also able to create and navigate the signal hierarchy in case the signal is part of a tree of context. Other than providing information on an open state, a gate can also provide additional features or outputs to justify or elaborate its state. Gates may also have dependencies that allow them to operate in sequence with other gates whose output might be needed for them to function. Therefore, a gate operates after all gates on which it has a dependency, have finished. Gates take signals as input and provide signals as output. However, unlike a TNN, the input signal to a gate may be used by the gate to create an entirely new signal and to send out that signal. For example, the inputs to a record builder gate is a set of field prediction signals and the output is a set of predicted record signals.

As the signals move through the gates, they either pass through or get blocked by different gates. Each signal carries the information about which gates allowed it and which gates blocked it. Gates are classified into different types based on the type of operations or roles they perform. The different types of gate roles are broadly as follows:

Checker Gates: These are training gates that collect information from verified document signals and prepare the data to be used by other gates.
Predict Gates: These gates use the information gathered from the Checker Gates to identify candidate values and wrap the candidate values in signals.
Filter Gates: These gates use the Checker Gate information to filter out the candidate values that are considered as noise.
Strategy Gates: These gates use the Gate States such as open or closed of the Checker Gates, the Predict Gates and the Filter Gates on each signal to decide which signals have a higher probability of being relevant. These gates then open up to the signals that are deemed relevant to the current use case being addressed by the system 100.

Each gate can train itself by looking at user verified data that it compares against its own predicted data. The gates are used to decide if a specific signal may be passed or not. The gates can be configured in such a way that different paths can be followed based on different conditions. The gates can also send metadata to the signals which can be used for further processing.

Signal: The signal is composed of some level of candidate/labeled data coupled with a contextual marker. A signal may be part of a signal hierarchy allowing navigation up and around the tree. The labeled data are wrapped by signals that are used by preliminary Checker Gates that perform training on this data. The Predict Gates then use these signals as input and can create candidate values for the different fields wrapped into signals. These then pass through the Filter Gates. Finally, the prediction architecture 114 may decide to use or ignore these candidate value signals by passing them through the Strategic Gates.

The signals may be hierarchical, and each gate can decide which type of signals can be processed. A signal hierarchy is created as the top-level signal passes through each gate in the gate network 116. The following is an example signal hierarchy:

The following operations are performed in the prediction workflow of the prediction architecture 114.

Scenario Identification: Gates that process the different contextual markers are activated, to have some segregation for similar or related types of contextual marker gates. This helps set up gate dependencies appropriately. Based on the specific set of contextual markers in play for a given field, the scenarios may be broadly classified as follows:

Contextual: This scenario primarily uses semantic markers that rely on NLP or other text-based prediction strategies.
Graphical: This scenario primarily focuses on the graphical positioning of the data with respect to page layout elements that may include, but are not limited to, borders, images, headers and footers.
Tabular: This scenario is a special case of graphical data where the data repeats in a left to right, top-down fashion.

The scenario identification is done at a field level to then choose the specific gates to be involved in the prediction activity.

Scenario Category Prediction: For the field level prediction, once enough data has been verified by the user, the prediction architecture 114 checks which scenario (Contextual/Graphical/Tabular) is occurring many times and picks that up as the category of focus. Once this category has been predicted for any given use case, the gates that use contextual markers of this category are assigned higher weightage.

Strategy Selection: Utilizing the weightage of the scenario category provides higher priority to the gate subnetworks for that category. On top of this, the network also tracks actual real-world performance of each gate based on user verification of predicted data. The feedback from this verification provides positive or negative bias points towards the different gates. The total bias points that a gate gathers enables strategies to form automatically as a collection of high positive bias gates that are then used for future predictions.

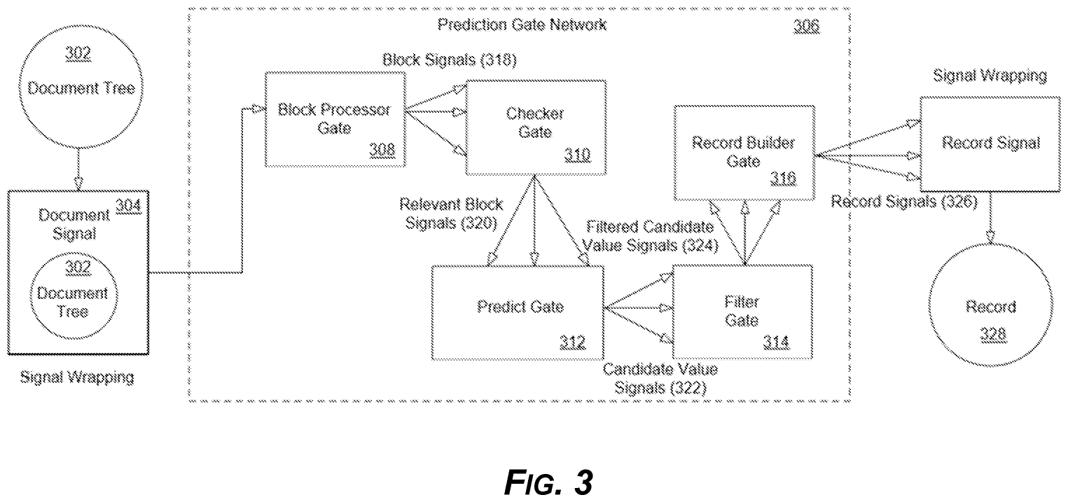

The prediction process of the gate network 116 for data extraction is described in conjunction with FIG. 3.

In accordance with an embodiment, extraction of blocks from tabular layouts is illustrated. Identification of tabular data patterns is a challenge due to lack of indicative markers in certain cases (such as, but not limited to, PDFs). For simplicity, tabular data in this respect is categorized into 3 types, A, B and C as follows:

‘A’ Table includes tables with graphical lines bound by every cell.
‘B’ Table includes tables in which one of the dimensions, either rows or columns have grid lines completely defined.
‘C’ Table includes tables that neither have rows or columns completely bound by graphical lines.

The detection of these tabular variations is performed using the gate network 116, that progressively builds up the different scenarios for Types A, B, and C. The gate network 116 utilizes the relationship between graphical lines and word blocks to detect tabular cell blocks (represented as general blocks). These challenges are not handled effectively by typical Machine Learning (ML) libraries available for integration. Therefore, the gate network 116 is introduced as an adaptive mechanism to discover and represent these constructs.

The gate network 116 for detecting cell blocks of a table includes various gates/neurons that check for specific features that may include, but are not limited to, inter-word gap, inter-line gap, font size/color, and relative position to other word blocks. In an embodiment, a decision maker gate at the end of the sequence uses gate states from all the gates to decide which word blocks should roll up to a higher-level block. As more scenarios are discovered, the gates that detect the new features are added to the network to address the solution in a progressive manner.

In accordance with an embodiment, extraction of entity chunks using the gate network 116 is illustrated. Typical entity recognition approaches focus on delivering contiguous words as entity candidates. However, the representation format used in this case allows entities to be detected as a simple combination of various contiguous and non-contiguous word blocks. In addition, it also allows various entities to be related together whenever use cases demand.

For example, consider the sentence, “The company has recorded total revenue for the three and six months ending Mar. 31, 2012 of $333 and $555.” In the example sentence, the words “three” and “months ending Mar. 31, 2012” form the two chunks of the entity ‘period’. The words “six months ending Mar. 31, 2012” form another entity ‘period’.

The block representation used in the data tree representation makes it easier to represent and detect such complex entities. Thus, new entities may be added to the prediction architecture 114 and may be incorporated at any stage of evolution of the gate network 116.

A list of entities currently included as part of implementation of the prediction architecture 114 may include, but are not limited to, Date, Period, Currency, Value, Multiplier, Location, and Name.

In addition, it is possible to establish and represent related entities. For example, consider the phrase, “$15 (Figures in millions of USD)”. In the example, the entities are as follows:

### Value: 15; Currency Symbol: $; Currency Code: USD; Multiplier: Millions

All the four entities are related, and this relationship is represented as a compound entity such as CurrencyValueMultiplier. The details of such entities discovered are added to each word block comprising the entity chunks. This is made available to the plurality of gates/neuron 118a-118n during training and prediction.

The training data preparation module 120 may comprise suitable logic, interfaces, and/or code that may be configured to construct training data for the prediction architecture 114, which includes labeled or verified data received from a user and associated context. The plurality of gates/neurons 118a-118n may comprise suitable logic, interfaces, and/or code that encapsulate the training data preparation module 120 to construct training data for the network or the gates in the network, which includes labeled/verified data and also metadata collected from labelled contexts.

Labeled data from a user, may be represented by records which comprise fields. Each field may comprise a single value, a phrase or even a paragraph. Each continuous set of words selected as part of a field value is referred to as a chunk. Unlike typical labeling data requirements, phrases are also allowed that are spread across a sentence or even sometimes present in different parts of a paragraph or a page to be rolled into a field value.

For example, consider the statement, “The company has recorded total revenue for the three and six months ending Mar. 31, 2012 of $333 and $555.” In the example statement, the words “three” and “months ending Mar. 31, 2012” form the two chunks of the value in labeling ‘revenue’, when the field value for period is captured for $555.

The record building module 122 may comprise suitable logic, interfaces, and/or code that may be configured to construct one or more records based on one or more candidate data values derived from the data tree representation using the gate network 116. The one or more candidate data values derived from the data tree representation are wrapped in one or more signals and fed to one or more gates/neurons of the plurality of gates/neurons 118a-118n to construct the one or more records.

FIG. 2 is a block diagram that illustrates data extraction through contextual markers and structural markers in accordance with an exemplary embodiment of the disclosure. Referring to FIG. 2, there is shown a block diagram 200, which includes a structured space 202 that includes export data 204 and fields/records 206, an unstructured space 208 that includes document content 210 and chunks/blocks 212. The block diagram 200 also depicts block signature 214 and combination sets 216.

Hybrid modeling of data is performed to simplify the extraction approach which includes dividing the solution into two parts: the structured space 202 and the unstructured space 208. The structured space 202 includes the export data 204 represented as records built from the fields/records 206. The unstructured space 208 includes the document content 210 represented as the chunks/blocks 212.

To obtain the document content 210, data from across multiple file formats including, but not limited to, PDF, HTML, TEXT, XLS and WORD is exported and uploaded, without loss of context and meaning. Beyond the primary file formats, the system 100 is extendable to a broad range of other formats that are used to represent a combination of free-flowing text and data in grids and/or graphical layouts. The storage format may be represented in any programming language that allows nested data structures consisting of objects and arrays. In an implementation, the system 100 uses JavaScript Object Notation (JSON) format for simplicity.

The document content 210 is parsed to extract information from the documents which includes determining context from the text that surrounds a candidate segment in addition to graphical/visual relations that exist in the information.

Consider the unstructured space 208 to be made up of groups of words collected from blocks, referred to as chunks. Each chunk represents one field of a record and comprises only the text that is expected to make it into the structured space 202. In this scenario, there may be words in the content that appear around the chunk or sometimes in between the words of the chunk, that provide additional context, but are not included in the chunks. These play the role of contextual markers only.

Operation of data extraction through contextual markers and structural markers is illustrated as follows:

Extraction of data based on contextual markers: For field values that are extracted from flowing text (sentences/paragraphs), various chunks that are to be part of the value of a field are captured. In addition, some chunks which provide the additional context to the value are captured. These are included in the field meta information as contextual markers.
For example, when extracting the % of women in the board of directors for a company from the following sentence, “We are committed to diversity among our employees, executive officers and on our board. We plan to increase the number of diverse persons to 27% by 2023”. Here, the field value is “27%” and the contextual markers are “women” and “diversity”.
In addition to the explicit contextual markers, additional information about the relative positioning of the values of different fields of a given record are also captured as implicit contextual markers. These indicate if the values appear relatively in the same sentence, in the same paragraph, in the same page or how many sentences apart.
Extraction of data based on structural markers: For field values extracted from other scenarios where textual context is not present, visual markers are used that may include, but are not limited to, absolute coordinates for a field, relative coordinates between fields, relative positioning with respect to other page elements such as keywords, headers, images, and graphical lines. These may be explicitly provided by a user in cases where there is a name and value appearing together (typically in forms) or may be implicitly identified by considering the graphical coordinates of the blocks from which the values are selected.

In the extraction process, the first step is to define connection elements that connect or correlate the structured space 202 and the unstructured space 208. These connection elements comprise the chunks/blocks 212. The chunks appear within a block. Each record in the structured space 202 comprises one or more blocks comprising the chunks that make up the fields of that record. A block may have chunks from one or more records and similarly a single record may have fields coming from chunks of different blocks. In order to simplify this relationship, another parallel structure is created to make the relationship more coherent.

For each block which has chunks coming from different records, two connection elements are considered. The first element is the block signature 214. The block signature 214 includes just the text of the block with the text of each chunk replaced by a field identifier (which is the field name of the corresponding field).

For example, consider the following sentence from which the revenue_value field and the revenue_period field, are to be extracted, “The company has recorded total revenue for the three and six months ending Mar. 31, 2012 of $333 and $555.” After the replacement of the chunk identifier (the field name is used as a field identifier for readability), the following block signature is obtained:

The company has recorded total revenue for the revenue_period and revenue_period of revenue_value and revenue_value.

The second connection element is the combination sets 216 which comprises a set of combinations of chunks that are created from the block signature 214. Each combination in the combination sets 216 represents one record that may be created. The combination sets 216 is a map of field ids to chunk position in the block signature 214. Therefore, when a combination is applied to the block signature 214, the fields of a record are assigned the text from the corresponding chunk positions in the block signature 214.

For example, consider the sentence, “The company has recorded total revenue for the three and six months ending Mar. 31, 2012 of $333 and $555.” The combination signature for the specific block signature is as follows:

[Record132 >revenue_period1, revenue_value1, Record2=>revenue_period2, revenue_value2]

Consider an example for a more complex scenario, “The company has recorded total revenue for the three and six months ending Mar. 31, 2012 of $333 and $666 (2011—$111 and $222).” In this example, combination signatures are linked to the block signature 214 to allow for a quick record building.

Thus, the chunks may be identified in a fresh block through a rule-based or a deep learning approach and the block signature 214 may be created, based on the candidate fields that the chunks represent. In accordance with an embodiment, a deep learning classification algorithm predicts the combination signature that the block signature 214 represents most closely. Once identified, the combination is applied to the block signature 214 and the corresponding records are extracted.

While the block signature 214 is most significant in building records for a sentence-based context, the hybrid modeling of data to include structure and context takes into account features that provide visual relevance to various cells or other types of nodes in the tree. The two principles used in this process are as follows:

Line of sight refers to all cells that can be reached from a given cell by going in one direction repeatedly, for example, left or up.

Reflected sight refers to all cells that can be reached by taking a right-angled direction from any cell that is in the line of sight of the current cell.

Based on these principles, linear directional connectivity of chunks is established. Further, for tabular layouts, the aspect of Reflected Distance is an important principle taken into consideration. When traveling along a line-of-sight or a reflected-line-of-sight, the reflected distance of any target block from a source block is provided by the number of steps retraced along the traversal path after reaching the last block in that line of sight.

Consider the following table as an example,

TABLE

| | 2019 | 2020 |
|---|---|---|
| A | 12 | 22 |
| B | 14 | 24 |
| C | 16 | 26 |

In the example table, if 2019 and 16 are extracted as 2 fields, the distance of 2019 from 16 is just 1. If 12 and 16 are extracted, the distance of 12 from 16 is 2, and so on. Therefore, as shown in the table, for 16, it is required to move all the way to the top (boundary of the table) and then count how many steps are retraced to get to either 2019 or 12. This is then the distance number attached to the connection between the two. It is seen that the distance between 16 and 2019 is 1, 14 and 2019 is 1, and 12 and 2019 is 1. This allows the gate network 116 to learn which ones are header fields.

FIG. 3 is a diagram that illustrates a prediction workflow of a prediction gate network for data extraction in accordance with an exemplary embodiment of the disclosure. Referring to FIG. 3, there is shown a prediction workflow 300, which includes a document tree 302, a document signal 304, a prediction gate network 306 which includes a Block Processor Gate 308, a Checker Gate 310, a Predict Gate 312, a Filter Gate 314, a Record Builder Gate 316, Block Signals 318, Relevant Block Signals 320, Candidate Value Signals 322, Filtered Candidate Value Signals 324, Record Signals 326 and a Record 328.

The document tree 302 is the data tree representation that is constructed based on the plurality of data elements extracted from the source document. The document tree 302 is wrapped in the document signal 304 and is provided to the prediction gate network 306.

The prediction gate network 306 allows the creation of multiple ensembles of models based on the needs of each business case for each stage of the information extraction. The models are auto selected by a strategy manager gate that evaluates a best fit ensemble for any given use case.

The prediction gate network 306 comprises a plurality of nodes representing the neurons/gates and the lines connecting the nodes to form the shape of the gate network 116. The signals pass from gate to gate through links between the gates. A gate may open or close to a signal depending on an activation function. The prediction gate network 306 comprises activation functions based on a predefined logic. In some embodiments, an individual gate/neuron encapsulates an entire gate network to provide a hierarchical prediction flow/logic.

Referring to FIG. 3, the prediction gate network 306 includes the Block Processor Gate 308, the Checker Gate 310, the Predict Gate 310, the Filter Gate 312, and the Record Builder Gate 314.

The document signal 304 is fed to the Block Processor Gate 308 of the prediction gate network 306. The Block Processor Gate 308 processes the document signal 304 based on an activation function defined for the Block Processor Gate 308 and outputs the Block Signals 318 that are fed to the Checker Gate 310.

The Checker Gate 310 are training gates that collect information from verified document signals and prepare the data to be used by other gates. The Checker Gate 310 processes the Block Signals 316 and outputs Relevant Block Signals 320 that are fed to the Predict Gate 312.

The Predict Gate 312 uses the information gathered from the Checker Gate 310 to identify candidate values and wrap the candidate values in signals to form the Candidate Value Signals 322 that are fed to the Filter Gate 314.

The Filter Gate 314 uses information from the Checker Gate 310 to filter out the candidate values from the Candidate Value Signals 322 that are considered as noise. The Filtered Candidate Value Signals 324 are then fed to the Record Builder Gate 316.

The Record Builder Gate 316 processes the Filtered Candidate Value Signals 324 based on the activation functions and outputs the Record Signals 326. The Record Builder Gate 316 encapsulates its own gate network to perform the work of record building with various gates/neurons that can activate for different record building strategies. The Record Signals 326 comprise the Record 328 that is wrapped up in the Record Signals 326.

The Record 328 may be built based on different algorithms. For instance, the Record 328 may come from the same sentence, from a table or even from a few values from a table, few from sentences, and a few from other places. The prediction gate network 306 uses multiple ways to find the best strategy to create the Record 328.

Initially all the gates are open to all the signals. Once the training data becomes available, the gates that create candidate data values get activated and can conditionally respond to Signals. When the candidate data values improve in recall and precision, the Filter Gate 314 gets activated and finally the Strategic Gates (a special form of the Filter Gate 314) get activated and provide the final prediction signals from the network. Whenever a new training data comes in, the prediction gate network 306 predicts an existing document and compares it with the actual values. This helps to evaluate learning algorithms and decide the best algorithm to employ.

In accordance with various embodiment, the implementations of the prediction gate network 306 for data extraction are further illustrated.

Tabular Layout Detection: Using the three types of tabular layout scenarios A, B and C, gates are created that detect each feature of each of these types of tabular layouts and Strategy Gates then predict how word blocks inside the tables are combined effectively into general blocks. In addition, it also helps create the directional relationship between the various general blocks of a table.

Entity Recognition: Using the chunked representation of the word blocks, gate networks are created to utilize the various features of each type of entity to create Entity Chunks and Compound Entity Types. If a certain industry needs a new type of entity to be recognized (for example, medical units), relevant gates are used that identify features of these entities to enable the prediction gate network 306 to grow its entity sensitivity.

Page Layout Clustering: In cases where the page layout plays a major role in prediction, a layout identification mechanism based on clustering is done by prediction gate network 306 which adds this metadata to the page blocks inside documents, to be used for prediction later. Besides using traditional clustering algorithms, gates can also combine them with the document metadata passed in during document upload and utilize their correlation with the labeled pages. Further refining of clusters based on the similarity of images within a cluster is handled by a subnetwork of gates.

Logo Detection in Pages: To detect a logo on a page, the text, color present on the logo and the aspect ratio of the logo and the page is used in the gates. In an embodiment, a gate wrapping the Scale-Invariant Feature Transform (SIFT) similarity algorithm helps compare the images on a page with the collection of logos so that there is only a less number of comparable images on the page as well as number of logos to choose from.

Field Prediction: Field prediction utilizes the prediction gate network 306 to the maximum. Multiple networks help in detecting candidate values for each scenario category (Contextual, Graphical and Tabular). In addition, Strategic Gates help assess the priority of each category for any given use case.

Record Building: Gate Networks help extensively in taking the candidate value signals from the field prediction networks and deciding records that can be built from them. The main categories of record building approaches include, but are not limited to, Single record per document, Multiple records, Single Record per block Multiple Records per block, and Tabular block Records. By implementing the gates for features of each approach, Strategic Gates can find the right combination of approaches to be used for any use case, thus improving the chances of successfully creating a relevant record even across scenarios.

Anomaly Detection: Gate Networks use text similarity and clustering to find present patterns in data. After that we use text embedding and classification models to find any outlier or new pattern. System automatically analyzes the predictions and looks for anomalies. When a new pattern is found or an anomaly is found, the system makes sure that the document is sent to be verified by the user. This effectively reduces the number of documents where a human will need to actively verify the predicted data.

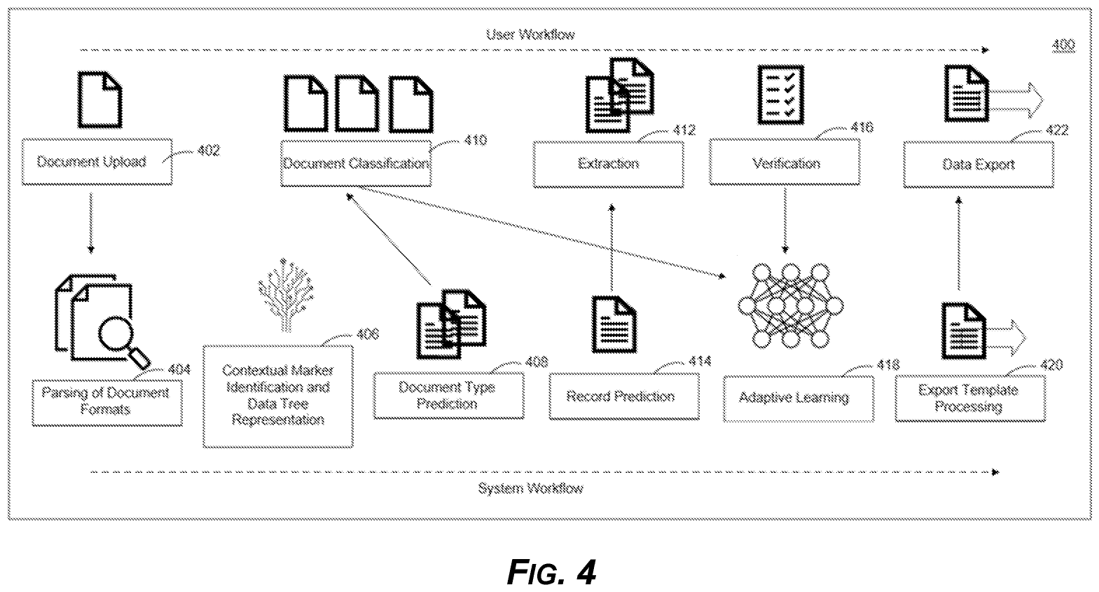

FIG. 4 is a diagram that illustrates a process workflow for contextual and positional parameterized record building in accordance with an exemplary embodiment of the disclosure. Referring to FIG. 4, there is a shown a process workflow 400 depicting operations for contextual and positional parameterized record building. The upper layer of the process workflow 400 represents a user workflow and the lower layer of the process workflow 400 represents a system workflow. The arrows indicate interactions or data flows between the two workflows.

Document upload 402: In this operation, a user uploads documents of specific file formats to the system 100.

Parsing of document formats 404: Depending on the file format, information may be directly read from a file or may be derived. The software used for reading the specific file formats may either be open source or may be provided by an entity that created the file format. Such software is integrated into the pipeline for the extraction workflow. In some cases, additional processing is performed on the data read from the file format in order to pull out specific metadata that is required. For example, graphical lines and text in the case of image representations are parsed using digital image parsing and OCR software.

Contextual Marker Identification and Data Tree Representation 406: In this operation, one or more contextual markers are extracted from around one or more chunks. These contextual markers provide additional context. Extraction of data may be represented by records which comprise fields. Each field may comprise a single value, a phrase or even a paragraph. The data tree representation is constructed which indicates conversion of all discovered and deduced graphical and text data that preserves hierarchy of a structural organization.

Document Type Prediction 408 and Document Classification 410: Categorization of documents may be done based on either business characteristics or technical characteristics. Classification based on business characteristics enables separating documents based on purpose or business context. This means that the data extracted from a given category of these documents will be more coherent and better connected. This in turn allows the system 100 to better manage data extraction needs.

Further, classification may also be based on technical characteristics to help with various automation tasks. Document format categories help in selection of content extraction technologies such as Extensible Markup Language (XML) reader or OCR engines.

Layout categories such as, but not limited to, flowing text, forms, structured layouts, tables and handwritten content allow selection of extraction approaches such as, but not limited to, NLP, Magnetic Ink Character Recognition (MICR), and handwriting recognition. Language categories allow more specific application extraction logic to the context and may have technical implications based on algorithmic support for those languages. Size classification such as, but not limited to, single page, multi-page (<100), large multi-page (>100), may entail further considerations in infrastructure requirements or even choice of algorithms for the extraction.

Extraction 412 and Record Prediction 414: Once the required information in a document is detected, individual pieces of the required data are identified. This may include simple values that go into fields that may be combined to form records or may include paragraphs of information that need to be parsed to summarize or identify constructs that indicate ideas of interest. The information may also include simple pieces of data that are connected directly to the document itself. The pieces gathered from the document are correlated into records that provide meaning and value to a specific business use case. Relationships between different candidate values are established accurately and semantic complexity of values are resolved.

Verification 416: When a new pattern is found, or an anomaly is found in a document, the document is sent to be verified by a user. This effectively reduces the number of documents that a user will need to actively verify the predicted data.

The relevant data in the documents is identified using either an automated or a manual approach using intuitive UI/User Experience (UX) systems that cuts down the time spent in extraction or labeling.

In an automation approach, the quality and integrity of data being extracted is ensured. A useful consideration is to ensure the labeling software captures not only the actual text but also its coordinates. The coordinates include both graphical x, y positions in a document, and a pathway (such as, but not limited to, CSS paths and Xpaths), to reach a data item.

For a manual process, higher level analysts or Subject Matter Experts (SMEs) may be involved to validate the extracted data and provide feedback. Two key features of this process are as follows:

The supporting UI/UX may allow the SME to quickly get to the actual data, check its authenticity, and its correlation to other labeled data. As such, a smart UI may provide some helpful mechanisms to cut down on the activity by reducing the clicks per record and/or field.
Tracking the verification time spent per document. This can give the business insights into cost of quality and help manage verification efficiency.

For an automated process, the human-in-the-loop reviews the predictions from the system, indicates any issues and corrects any wrong predictions. Two key considerations in this process are as follows:

Collecting all these inputs from a user and providing it to the prediction system in a way where it can utilize the information to improve the learning models.
Another aspect is the consideration given to the number of documents and to which documents need to be sent for human verification. This has a direct impact on the efficiency of the entire process and effort/cost of using the overall system.

In certain scenarios, a verification team may be trained to be sensitized to the nuances of the automated learning system in order to avoid confounding labeling from going into the system. For example, consider that a document has two records and a user has selected the document published date from one location for the first record and another location for the second. From a human point of view, the two locations may both be relevant but for a machine the variance may lead to some delay in reaching satisfactory levels of efficiency.

Adaptive Learning 418: This operation employs the prediction architecture 114 which comprises an ensemble of models, which are auto selected by top-level strategy manager Gates based on the use case chosen or data labeled by the user. The prediction architecture 114 includes the following components:

The Gate Network which is an adaptive/extensible network architecture that manages Gates/Neurons.
The Gate/Neuron which is a model or an ensemble of models and strategy manager Gates.
The Signal which comprises a contextual marker and labeled data wrapped up into a single unit.

The Gate Network is designed with the features of documents and use cases. Any given use case that has been trained by the Gate Network may be easily enhanced by simply dropping new Gates/Neurons into the Network. The dependency relations and the Strategy Management inherent in the Gate Network adopts the new Gate into the flow and carries on predictions going forward.

The Gate Network architecture is built to be flexible and robust enough to be plugged into various stages of the data extraction workflow. By wrapping a Gate Network into a single Gate, the Gate Network becomes part of a larger Gate Network, thus allowing recursive and hierarchical extraction pathways to be implemented.

Export Template Processing 420 and Data Export 422: These operations involve exporting data from an application to a data file. The data file is used to load data into an Enterprise Resource Planning (ERP) application or an external system.

The present disclosure is advantageous in that it provides a system to accurately represent data from across multiple file formats including, but not limited to, PDF, HTML, TEXT, .XLS and WORD without loss of context and meaning. Beyond the primary file formats listed, the disclosure is extendable to a broad range of other formats that are used to represent a combination of free-flowing text and data in grids and/or graphical layouts. The storage format may be represented in any programming language that allows nested data structures consisting of objects and arrays.

The system of the disclosure can efficiently handle any text-based formats such as, but not limited to, TEXT, HTML and XML, internally through standard handling procedures available in the public domain. For the purpose of reading and understanding non-text file formats such as, but not limited to, .XLS, WORD, PDF and images, the system utilizes external systems/software that are available in free public domain or may integrate vendor-licensed reading systems.

Those skilled in the art will realize that the above recognized advantages and other advantages described herein are merely exemplary and are not meant to be a complete rendering of all of the advantages of the various embodiments of the present disclosure.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus/devices adapted to carry out the methods described herein may be suited. A combination of hardware and software may be a general-purpose computer system with a computer program that, when loaded and executed on the computer system, may control the computer system such that it carries out the methods described herein. The present disclosure may be realized in hardware that comprises a portion of an integrated circuit that also performs other functions. The present disclosure may also be realized as a firmware which form part of the media rendering device.

The present disclosure may also be embedded in a computer program product, which includes all the features that enable the implementation of the methods described herein, and which when loaded and/or executed on a computer system may be configured to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A system for contextual and positional parameterized record building, the system comprising:
a memory;
a processor communicatively coupled to the memory;
a prediction architecture communicatively coupled to the processor, wherein the prediction architecture comprises an ensemble of models, each model in the ensemble of models comprising a gate network having a plurality of gates/neurons, wherein each gate/neuron of the plurality of gates/neurons is associated with an activation function based on a pre-built logic to perform a specific operation and wherein each gate/neuron is configured to operate on one or more signals received at the each gate/neuron;
a data representation module communicatively coupled to the processor, wherein the data representation module is configured to perform hybrid modeling on a plurality of data elements to represent data in a structured space and an unstructured space, wherein the data representation module is configured to construct a data tree representation using the prediction architecture to correlate the structured space and the unstructured space, wherein the data tree representation comprises a plurality of hierarchical blocks to represent the plurality of data elements along with relative positions of each of the plurality of data elements with respect to each other; and
a record building module communicatively coupled to the prediction architecture, wherein the record building module is configured to construct one or more records based on one or more candidate data values derived from the data tree representation using the prediction architecture, wherein the one or more candidate data values derived from the data tree representation are wrapped in one or more signals and fed to one or more gates/neurons of the plurality of gates/neurons to construct the one or more records.

2. The system of claim 1, wherein the plurality of data elements comprise at least one of text, images, words, letters, image coordinates, graphical lines, contextual and structural metadata, complex entities and high-level formatting constructs that include paragraphs, sentences, tabular constructs or layouts and cells along with actual text.

3. The system of claim 1 comprises a data element extraction module communicatively coupled to the processor, wherein the data element extraction module is configured to identify and extract the plurality of data elements from one or more source documents.

4. The system of claim 3 comprises a data standardization module communicatively coupled to the processor, wherein the data standardization module is configured to normalize the plurality of data elements extracted from the one or more source documents.

5. The system of claim 4, wherein the data standardization module is configured to normalize the plurality of data elements by connecting graphical lines that are broken or overlapping, in the case of Hypertext Markup Language (HTML) content, identifying various Cascading Style Sheets (CSS) pathways that identify different word constructs within a Document Object Model (DOM), removing redundancies and inconsistencies in certain document formats, removing text hidden by overlapping layers and unifying lines overlapping each other.

6. The system of claim 1, wherein the structured space comprises data represented as one or more records built from one or more fields.

7. The system of claim 1, wherein the unstructured space comprises one or more documents represented as one or more blocks, wherein each block of the one or more blocks comprises one or more chunks, wherein a chunk comprises one or more fields of a record.

8. The system of claim 7, wherein, for each block of the one or more blocks having chunks from different records, the data representation module is configured to generate one or more block signatures, wherein a set of combinations of chunks are created from a particular block signature of the one or more block signatures.

9. The system of claim 7, wherein the data representation module is configured to extract one or more contextual markers from around the one or more chunks, wherein the one or more contextual markers provide additional context.

10. The system of claim 7, wherein the data representation module is configured to extract one or more structural markers, wherein the one or more structural markers comprise visual markers for one or more field values extracted from scenarios where textual context is not present, wherein the visual markers comprise absolute coordinates for a field, relative coordinates between fields, and relative positioning with respect to other page elements that include keywords, headers, images, and graphical lines.

11. The system of claim 1 comprises a training data preparation module communicatively coupled to the prediction architecture, wherein the training data preparation module is configured to construct training data for the prediction architecture, wherein the training data comprises labeled or verified data received from a user and associated context.

12. The system of claim 1, wherein the gate network organizes the plurality of gates/neurons into a right sequence and activates appropriate gates/neurons of the plurality of gates/neurons for a scenario, wherein the scenario comprises at least one of contextual data, graphical data and/or tabular data and wherein an individual gate/neuron encapsulates an entire gate network to provide a hierarchical prediction flow/logic.

13. The system of claim 12, wherein the plurality of gates/neurons comprise Checker gates/neurons, Predict gates/neurons, Filter gates/neurons, and Strategy gates/neurons.

14. The system of claim 13, wherein the Checker gates/neurons comprise training gates that collect information from verified document signals and prepare data to be used by other gates/neurons of the plurality of gates/neurons.

15. The system of claim 13, wherein the Predict gates/neurons use information gathered from the Checker gates/neurons to identify candidate data values and wrap the candidate data values in signals.

16. The system of claim 13, wherein the Filter gates/neurons use information from the Checker gates/neurons to filter out candidate data values that are considered noise.

17. The system of claim 13, wherein the Strategy gates/neurons use gate states of the Checker gates/neurons, the Predict gates/neurons and the Filter gates/neurons on each signal to decide which signals have higher probability of being relevant.

18. The system of claim 1, wherein the one or more signals are hierarchical, and each gate/neuron of the plurality of gates/neurons decides which type of signals are to be processed.

19. The system of claim 18, wherein the one or more signals are composed of candidate data values or labeled data values coupled with one or more contextual markers, wherein the labeled data values that are wrapped by the one or more signals are used by the Checker gates/neurons to perform training, and wherein the Predict gates/neurons use the one or more signals as input and create candidate data values for different fields wrapped into the one or more signals.

20. The system of claim 19, wherein a signal hierarchy is created as a top level signal passes through each gate/neuron of the plurality of gates/neurons in the gate network, wherein the signal hierarchy comprises a document signal, a block signal, a record signal and a field signal.

21. The system of claim 20, wherein the plurality of gates/neurons are activated for identification of a specific scenario based on a specific set of contextual markers wrapped in one or more signals for a given field.

22. The system of claim 21, wherein one or more gates/neurons of the plurality of gates/neurons that use contextual markers of a scenario category occurring multiple times are assigned a higher weight.

23. The system of claim 21, wherein the gate network tracks actual real world performance of each gate/neuron of the plurality of gates/neurons based on user verification of predicted data, wherein feedback from the user verification provides positive or negative bias points towards the plurality of gates/neurons, to form one or more strategies automatically as a collection of high positive bias gates/neurons to be used for future predictions.
